(19) United States
(12) Patent Application Publication
(10) Pub. No.: US 2005/0073585 A1
(43) Pub. Date: Apr. 7, 2005

(54) Tracking systems and methods

(75) Inventors: Gil J. Ettinger, Lexington, MA (US); Matthew Antone, Cambridge, MA (US); W. Eric L. Grimson, Lexington, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Alphatech, Inc., Burlington, MA (US)

(21) Appl. No.: 10/944,563

(22) Filed: Sep. 17, 2004

Related U.S. Application Data
(60) Provisional application No. 60/504,583, filed on Sep. 19, 2003.

(51) Int. Cl. H04N 7/18

(52) U.S. Cl. 348/155

(57) ABSTRACT

Methods, systems, and computer program products for tracking an object(s), including identifying the object(s) by correlating video data from at least one video device, based on motion data of the object(s) for a previous time, determining that the object(s) movement is stopped, based on determining that the stopped object(s) is not occluded, monitoring the stopped object(s) properties, determining from the monitoring that the stopped object(s) is moving, and, resuming track of the object.

### CLAIM OF PRIORITY

This application claims priority to U.S. Ser. No. 60/504,583, filed on Sep. 19, 2003, the contents of which are herein incorporated by reference in their entirety.

### BACKGROUND

(1) Field

The disclosed methods and systems relate generally to tracking methods and systems, and more particularly to tracking in unstructured environments.

(2) Description of Relevant Art

Wide availability and low cost allow incorporation of high-quality cameras and fast processors into high-coverage commercial video surveillance and monitoring (VSAM) systems. Such systems typically produce enormous quantities of data too overwhelming for human operators to process. Video footage is often analyzed superficially, recorded without review, and/or simply ignored; however, high-coverage, continuous imaging provides a rich information source which, if used intelligently, can allow automatic characterization of normal site activities, detection of anomalous behaviors, and tracking of objects of interest.

Many video surveillance technology systems rely on face recognition or other biometrics, for example to screen airline passengers as they pass through heavily-trafficked areas. For a suspect to be identified, he/she must already be flagged as a potential risk and have a current feature set on file in the system's database. The effectiveness of such systems in correctly recognizing disguised or non-cooperative individuals is unclear at best. It is therefore desirable to augment identification systems with technologies that do not require a priori knowledge of specific individuals.

Robustness is thus an issue in such systems because of associated uncontrolled settings where viewing conditions and scene content may vary significantly. For example, variable viewing conditions under which the systems can operate include: (i) illumination (e.g., day/night, sunny/cloudy, sun angle, specularities); (ii) weather (e.g., dry/wet, seasonal changes, variable backgrounds (snow, leaves)); (iii) scene content variables including: (a) object density, speed, count; and, (b) size/shape/color within and across object classes; and, (iv) nuisance background clutter (e.g., shadows, swaying trees).

### SUMMARY

The disclosed methods and systems include monitoring applications in unstructured outdoor and/or indoor environments in which traffic of moving objects, such as cars and people, is characterized not only by motion triggers, but also by speed and direction of motion, size, shape, color of object, time of day, day of week, and time of year.

In one embodiment, the methods and systems receive as input one or more camera and/or video streams and produce traffic statistics on objects of interest in locations of interest at times of interest. These statistics provide an object-oriented basis on which to characterize viewed scenes. The resultant characterization can have a variety of uses, and in particular, large-scale applications in which many cameras monitor complex, unstructured locations.

In one embodiment, scene characterization technology can be employed to prioritize video feeds for live review, raise alarms for selected behaviors of interest, and provide a mechanism to index recorded video sequences based on their content.

Disclosed are methods, systems, and computer/processor program products for tracking an object(s), including identifying the object(s) by correlating video data from at least one video device, based on motion data of the object(s) for a previous time, determining that the object(s) movement is stopped, based on determining that the stopped object(s) is not occluded, monitoring the stopped object(s) properties, determining from the monitoring that the stopped object(s) is moving, and, resuming track of the object(s). The correlating can include spatially correlating and temporally correlating, and correlating can include providing a model of at least one field of view, and, registering the video data to the model.

For the disclosed methods and systems, resuming track can include creating a new track. Further, the stopped object(s) properties can include kinematic properties, 2D appearance, and/or 3D shape, and in some embodiments, the stopped object(s) properties can include arrival time, departure time, size, color, position, velocity, and/or acceleration. In the disclosed methods and systems, the video devices include at least two cameras having different fields of view.

In some embodiments, the disclosed methods and systems can include providing one or more alerts based on determining the object(s) as a stopped object(s) and/or providing at least one alert based on a lapse of a time since determining the object is a stopped object. In an embodiment, the methods and systems can include comparing the object(s) track to a model track, and, providing an alert based on the comparison of the track to the model track. In some embodiments, an alert can be provided based on an object entering an area/region, a time at which an object enters an area/region of interest, and/or an amount of time that an object remains in a region (e.g., regardless of whether the object is stopped).

The disclosed methods and systems can include, based on determining that the stopped object is occluded, monitoring new tracks of objects emanating from the region occluding the object. Also included is selecting a new track consistent with the track of the occluded object prior to the occlusion, and, associating the track of the occluded object prior to the occlusion with the selected new track.

In an example embodiment, correlating video data can include detecting motion in the video data to identify objects, classifying objects from background, segmenting the background, detecting background regions with changes, and updating the background properties based on determining that the changes are due to at least one of illumination, spurious motion, and imaging artifacts. In some embodiments, correlating video data can include detecting moving objects, and, grouping moving objects based on object tracks. Correlating video data can also and/or optionally include splitting groups of moving objects based on object tracks, where the splitting can include determining that at least one first object in a group is stopped, and, determining that at least one second object in the group is moving.

In some embodiments, the methods and systems can include correlating the track trajectory of the at object(s) from a first video device, correlating the object properties of the object(s) from a second video device, and, determining, based on the correlation of the track trajectory and correlation of the object properties, to merge at least one track from the first video device and at least one track from the second video device. Similarly, the methods and systems can include determining, based on the correlation of the track trajectory and correlation of the object properties, to not merge at least one track from the first video device and at least one track from the second video device, and, based on such determination, ending a track of an object and/or starting a track of an object.

Also disclosed are systems and processor program products having processor-readable instructions for performing the disclosed methods.

Other objects and advantages will become apparent hereinafter in view of the specification and drawings.

### BRIEF DESCRIPTION OF DRAWINGS

FIG. 1 illustrates components of the disclosed methods and systems;

FIG. 2 illustrates one embodiment of the disclosed methods and systems;

FIG. 3 illustrates a video frame displayed by a graphical user interface (left) that is registered with a top-down schematic map of a surrounding region (right);

FIG. 4 discloses a portion of one embodiment of the illustrated methods and systems;

FIG. 5 illustrates a portable pixel map (PPM) image of an object and a corresponding portable gray map (PGM) image thereof;

FIGS. 6 and 7 illustrate two examples of move-stop-move object tracking;

FIG. 8 illustrates one scheme for move-stop-move processing;

FIG. 9 shows a processing scheme for occlusion tracking;

FIG. 10 illustrates a dynamic background adaptation scheme; and,

FIG. 11 illustrates a scheme for tracking an object across multiple views.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems or methods of the present disclosure.

The disclosed methods and systems can detect, track, and classify moving objects and/or “objects of interest” (collectively referred to herein as “objects”) in video sequences. Objects of interest can include vehicles, people, and animals, with such examples provided for illustration and not limitation.

The systems and methods include tracking objects of interest across changing and multiple viewpoints. Tracking objects of interest through pan/tilt/zoom transformations improves camera coverage and supports effective user interaction (for example, to zoom in on a suspicious person). Tracking across multiple camera views decreases the probability of occlusion and increases the range over which we can track a given object. Objects can be tracked within a single fixed video sequence, and the method and systems can also correlate trajectories across multiple variable-view sequences.

The disclosed methods and systems can alert users to, and allow users and others to identify certain objects and events. Given the volume of video imagery collected in monitoring applications, most processing must be performed automatically and in real time, so that users need only review a small set of machine-flagged events and can cue to footage or objects of interest. An indexed database of activity can be maintained alongside the raw video data to facilitate such interaction. Accordingly, the methods and systems include a prioritization of multiple video feeds and an object-oriented indexing system to retrieve video sequences of objects of interest based on spatial and temporal properties of the objects.

Some processing and/or parameters of the disclosed methods and systems can include activity detection rate, activity characterization (speed, loitering time, etc.) rate, sensitivity to environmental conditions and activity types, tracking and classification through pan/tilt/zoom transformations, site-level reasoning, object tracking through stops, supervised classification learning, and integration of additional classifiers such as gait with existing size/shape/color criteria.

In one embodiment, the methods and systems include a behavior-based video surveillance system robust to environmental factors that include, for example, lighting, rain, and blowing leaves. By extracting spatio-temporal features such as color, size, shape, position, velocity, and growth rate, and integrating behavioral modeling therewith, statistics and alerts can be generated based on a detection of unusual activities (as determined by the embodiment). In some embodiments, an alert can be provided based on an object entering an area/region, a time at which an object enters an area/region, and/or an amount of time that an object remains in a region (e.g., regardless of whether the object is stopped).

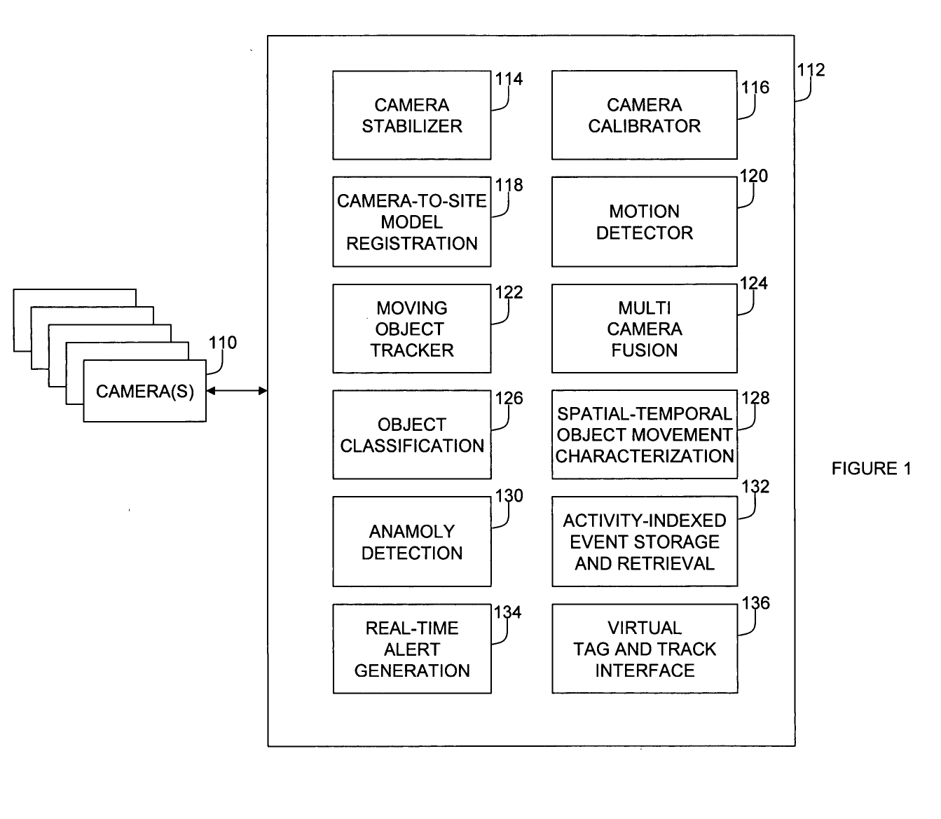

FIG. 1 thus shows a block diagram of one embodiment of the disclosed methods and systems. As shown in FIG. 1, the methods and systems can include one or more cameras 110 that can be understood to include one or more video devices. The camera(s) 110 can be analog and/or digital devices, and can be positioned at one or more geographic locations and/or fields of view. For example, simultaneous parallel tracking of a single object from multiple cameras can be performed. In one embodiment, a quad-multiplexor can be used to concatenate four video streams into one composite stream. This composite stream can be divided and/or split back into four half-resolution streams, each of which can be provided to its own instance of a tracker object. Four separate track databases can then be created and maintained as the stream progresses. Additionally and optionally, in an embodiment, separate data streams can be employed directly from their respective sources. A tracker can be instantiated for each feed, and tracking can proceed in parallel on the different streams.

As shown in FIG. 1, the camera(s) can provide data and/or be in communications with one or more processor systems 112 that can include various features for processing the camera data (or data based on the camera data) in accordance with the disclosed methods and systems. It can thus be understood that some systems may not include all of the features of the illustrated system 112, and as provided previously herein, components of the illustrated system 112 can be combined, interchanged, separated, etc., without departing from the scope of the disclosed methods and systems.

In the FIG. 1 embodiment, the processor systems 112 includes a camera calibrator 114 for issues related to relative camera location, normalize illumination conditions, and compute intrinsic and extrinsic camera parameters, for example, and a camera stabilizer 116 that can accept data from the one or more cameras 110 and modify such data to account for camera motion, pan, tilt, etc. It can be understood that the cameras 110 can be fixed, moving, and/or pole-mounted, for example. Such calibration and stabilization schemes can be based on the embodiment, and the disclosed methods and systems are not limited to a particular scheme. Also shown in FIG. 1 is a scheme for camera-to-site model registration processing scheme 118 that can include a processing scheme for registering the camera data (e.g., stabilized and calibrated camera data) to a model of the site/location that is associated with a camera 110 and/or a field of view, and thus may include a transformation of camera coordinates to world coordinates.

As provided herein, and as shown in FIG. 1, the camera/video data can allow for the detection, classification, and tracking and/or processing of objects. Such tracking and/or processing of objects can be correlated with time and location and recorded in one or more memories (e.g., database) that can further record physical features of the objects, including, for example, size, color, and shape of objects over time and location, which may also be recorded in a database 132. Accordingly, objects can be tracked and/or characterized based on object kinematics, 2D appearance, and/or 3D shape to allow for cross-track association of object data. Such data can be further correlated with other events that are not associated with the object(s) being tracked.

The FIG. 1 embodiment thus includes a motion detection processing scheme 120 and a moving object tracker 122, both of which can be of various forms based on the embodiment. For example, the motion detector 120 may detect objects of interest in cluttered and/or changing environments, such as people, vehicles, etc., while an object tracker 122 can maintain localization of moving objects within a camera's field of view to allow for continuous track through, for example, short occlusions and coverage lapses/gaps. An object tracker 126 can also be used to characterize and/or otherwise associate tracked objects with physical features of the objects. Such object tracking can allow for object classification 126 amongst a class of objects. Such classification can provide robustness amongst class appearance variabilities.

It can thus be understood that data from multiple cameras associated with a single site can be combined and/or fused by a camera data fusion processing scheme 124. In some of the disclosed embodiments, camera data fusion 124 can include fusion of camera data from multiple sites being provided to a fusion processing scheme 124 to allow for tracking between cameras/locations/fields of view and/or changing illumination conditions. Such object tracking over time and/or location can thus allow for a spatial-temporal object movement characterization 128 that can determine, for example, whether an object has moved between two locations in an exceptionally fast and/or an exceptionally slow manner, with such examples provided for illustration and not limitation. Accordingly, one embodiment of a spatial-temporal object movement characterization scheme 128 can allow for a development of motion pattern models of parameterized object trajectories to allow for an expression of a broad range of object trajectories. Such trajectories can be utilized by the FIG. 1 anomaly detector 130 which can include thresholds and/or other schemes (static and/or adaptive schemes) for determining whether an object's behavior, based on such tracking, may be considered an anomaly that should be associated with an alert 134. Deviations from models provided by the disclosed object movement characterization scheme 128 can thus be detected by an anomaly detector 130, where such deviations can be user/system administrator defined and/or characterized based on the embodiment.

As indicated in FIG. 1, the disclosed methods and systems can allow for a tagging of objects 136 as such objects are tracked, such that an activity-indexed database 132 can be arranged for data retrieval by object and/or tag to allow retrospective inspection of historical object tracks. The tagging of objects (e.g., selection by a user/administrator/another) can further allow for processing resources to be dedicated to tagged objects rather than non-tagged objects.

Queries to an activity-indexed database 132 can thus assist in the determination of anomaly behavior. The event data can further be stored using activity descriptors to maintain high transaction volume based on spatio-temporal parameters.

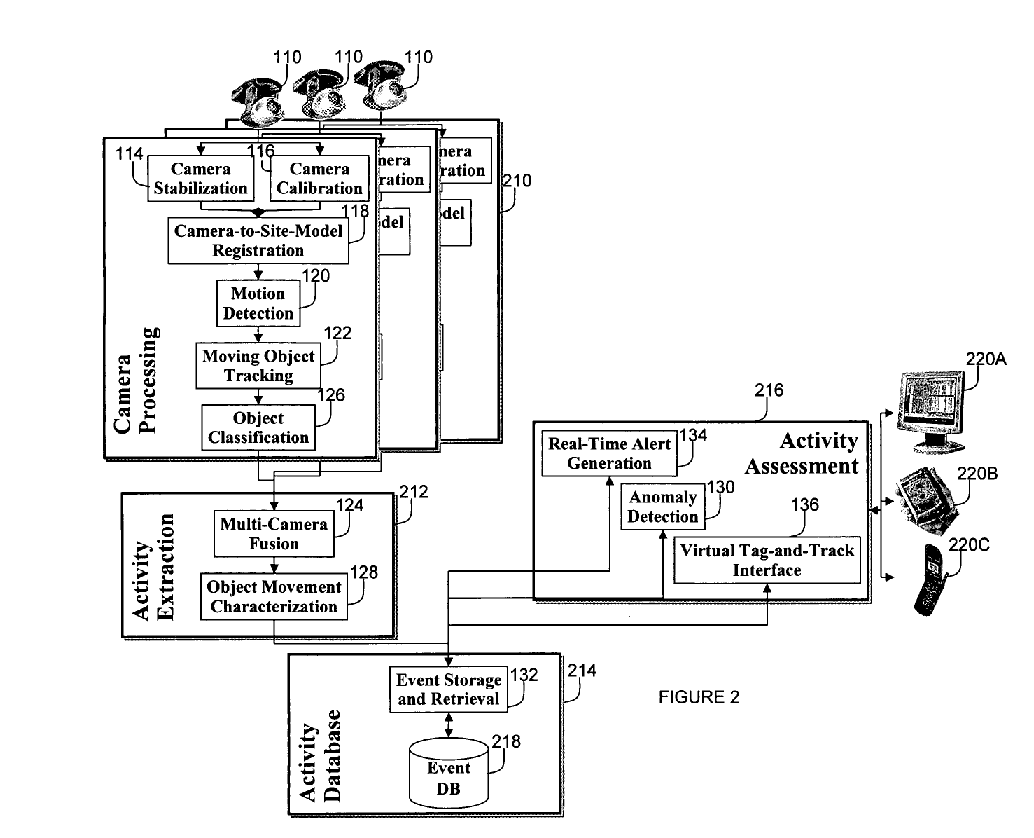

FIG. 2 presents another embodiment of a system according to FIG. 1, which includes, for example, a camera processing module 210 associated with each camera 110, an activity extraction module 212 to extract data from an object's track, an activity database 214 that provides for data storage/retrieval/archiving, and an activity assessment module 216 that allows for an assessment of the object activity based on the object'(s) track. As provided relative to FIG. 1, the FIG. 2 embodiment is also merely for illustration and the organization of modules is merely for convenience.

As shown in the FIG. 2 embodiment, multiple cameras 110 can be positioned at geographically distinct locations and/or fields of view, where in the FIG. 2 embodiment, each camera is associated with a camera stabilization 114 and camera calibration 116 processing scheme as provided previously herein. As FIG. 2 indicates, the stabilized and calibrated data can be provided to a camera-to-site model registration processing scheme 118 before being provided to a motion detection scheme 120 to identify objects for tracking 122 and classification 126. The tracked objects and classifications thereof from different cameras 110 can be provided to a single multi-fusion camera processing scheme 124 that can fuse data from multiple cameras at a single site and/or different sites. The fused data can thus allow for object movement characterization of objects 128 as provided previously herein.

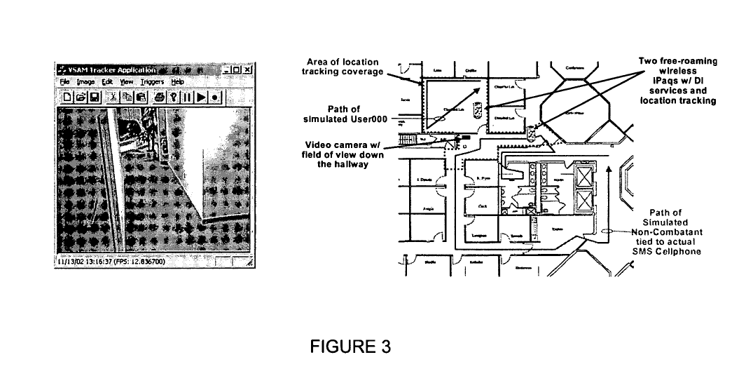

Accordingly, in one embodiment, cross-camera tracking can include projection of each camera's tracks into a common reference frame, or site map, as shown in FIG. 3, and correlating the tracks using the reference frame coordinates. As indicated herein, such a mapping includes pre-calibration of each video stream with the map. Several coordinate transformations can be used, and in one embodiment, a projective plane-to-plane model based on image homographies can be employed. A 3×3 homography matrix, H, can transform an image point in homogeneous coordinates p to a map point m according to:

$$m = \frac{Hp}{Hp \cdot \hat{z}} .$$

The eight parameters of the homography, hᵢⱼ, can be estimated by computing the least-squares solution to constraints of the form:
h₁₁x+h₁₂y+h₁₃−h₃₁xu−h₃₂yu=u
h₂₁x+h₂₂y+h₂₃−h₃₁xv−h₃₂yv=v
where p=(x, y) and m=(u, v) are known from manually-specified point pairs between the video imagery and the map. At least four such pairs are needed for a unique solution.

To support this projection of inherently 3D objects onto 2D surfaces, objects may be tracked according to their lowest point (e.g., bottom of a bounding box) rather than their center of mass. This is a more natural representation for object position with respect to the ground, since the scene is essentially projected onto the ground plane when transformed to map coordinates. In an embodiment, object tracks from the trackers can be transformed to map coordinates, and tracks can be associated across camera views based on kinematics.

With further reference to FIG. 2, the FIG. 2 event database 218 can store events that are detected and/or recorded by the disclosed methods and systems, and such events can be stored/retrieved using the illustrated event storage and retrieval scheme 132 that can associate events and/or event data with activity descriptors. The event database 218 can be accessed by a variety of processor controlled devices 220A, 220B, 220C, for example, that can be equipped with a tag-and-track user interface 136 that allows a user and/or another associated with the device 220A-C to identify and/or select objects of interest for tracking. As provided previously herein, the illustrated database 218 can allow for retrospective inspection of historical tracks, which may be accessed by and/or displayed on the processor-controlled devices 220A-C. As indicated in FIG. 2, the processor devices 220A-C may communicate using wired and/or wireless networks.

Communications can also be maintained between the processor devices 220A-C and the anomaly detection scheme 130 and/or the alert generation scheme 134. It can thus be understood that users of the processor devices 220A-C may configure the anomaly detection scheme 130 and/or the alert generation scheme 134 to allow, for example, conditions upon which alerts are to be generated, locations to which alerts should be directed/transmitted, etc.

The processor devices 220A-C can thus be provided and/or otherwise configured with customized software that can display a site map, read target tracks as they are generated, and superimpose these tracks on the site map. The customized software can also request current video frames, and generate audible and visual alerts while displaying image chips of objects as the objects cross virtual tripwires, for example.

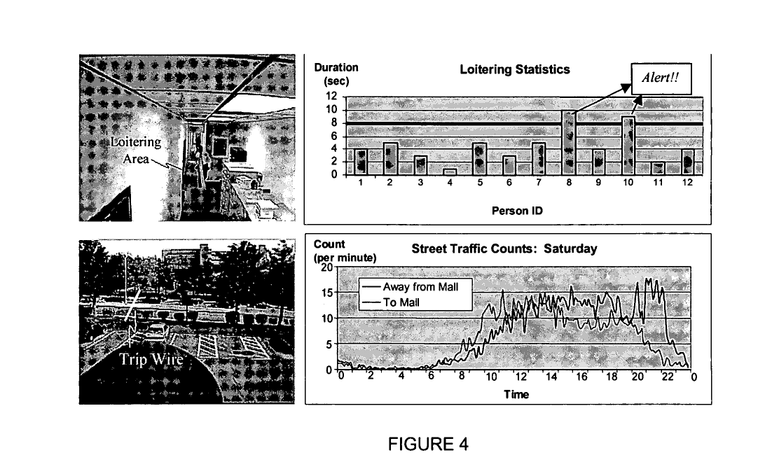

FIG. 4 depicts an example use of the disclosed methods and systems as provided herein as applied to detection of various behaviors within an office setting and at a mall entrance. In the top half of FIG. 4, one embodiment of the system monitors people in a hallway and collects information on their dwell time. Alerts can be generated to notify the appropriate security personnel of suspicious behavior (e.g., loitering). Also shown in FIG. 4 is the use of a virtual “tripwire” to detect objects that cross a pre-defined threshold. The system detects crossing events and motion direction to distinguish between a person/object entering and leaving an area of interest. Statistics gathered as individuals cross virtual tripwires can reveal characteristics, such as, for example, the volume of traffic leaving the mall increases dramatically near, for example, a time associated with mall closing, can suggest that additional security personnel may be needed during that time. Such an example includes tracking of moving objects, spatial and temporal activity characterization (e.g., object counts, speeds, trajectories), parameterization of activity patterns by time of day, day of week, time of year, and review of events of interest, as provided herein relative to FIGS. 1 and 2.

As further described relative to FIGS. 1 and 2, for a system and method such as that of FIG. 3, different cameras can be mounted at different locations, and thus the features that the different cameras observe can thus differ. Under ideal conditions, differences between camera observations are small, so that each camera can correctly and consistently identify a given object; however, effects such as lighting changes and perspective projection can hinder multiple-view fusion, such that the aforementioned camera models and computer vision techniques can be allowed to address this problem.

Further, as objects pass behind one another, the objects can be partially or fully hidden from view. Object tracks are commonly lost and must be reacquired when the object reappears. Partial occlusion may also undermine object identification, for example, when an individual on an escalator is visible only from the waist up. Such difficulties can be ameliorated by using multi-hypothesis tracking combined with kinematics modeling and classification. The use of overhead cameras can also assist in minimizing occlusion effects.

The methods and systems can employ virtual tripwires to detect pedestrian and vehicle traffic in the wrong direction(s). For example, in an aircraft/airport exemplary embodiment (an exemplary embodiment used herein for illustration and not limitation) while attendants and security personnel attempt to detect illegal movements through checkpoints and gates, automatic video-based detection and snapshots can complement such efforts. Virtual tripwires that incorporate directionality to provide an alert(s) when crossed in a specified direction can thus be employed.

Further, and continuing with an airport exemplary embodiment, with an increased threat of explosive devices that has expanded from aircraft to the concourse, heightened security measures dictate immediate confiscation and in some instances, destruction of unattended baggage. Such items are generally located visually by patrolling security personnel or reported by travelers, but may remain unnoticed for unacceptably long periods. The disclosed methods and systems thus provide airport security with automatic alerts when an individual places an item at a location and walks more than a specified distance away; and/or, when an item is observed unattended for more than a specified period of time.

Terrorist threats have expanded still further from the interior concourse to the exterior vehicle traffic circles. The disclosed methods and systems can thus provide one or more alerts when vehicles exceeding a specified size drive through drop-off/pickup areas. For example, trucks and cargo vans are rarely observed and may constitute suspicious activity. The disclosed methods and systems can learn “normal” vehicle size through long-term observation and flagging vehicles exceeding this “normal” size. In some embodiments, the methods and systems can be programmed and/or otherwise configured to identify and/or provide an alert regarding vehicles exceeding an explicit user-defined size.

Since no single fixed-view camera can view entire large sites such as airports, individuals and vehicles can be tracked over long temporal extents by camera-to-camera handoff using the multiple camera scenarios illustrated herein. Such a capability, optionally together with tag-and-track capability can allow an operator to graphically indicate an object of interest, and track its movement across coverage gaps and occlusions, also obtaining its previous motion history.

Further, the gathering of statistics such as average queue lengths, traffic flow, and wait times in various locales can allow, for instance, re-allocation of staff at different times of day, or re-routing of traffic to address increased congestion.

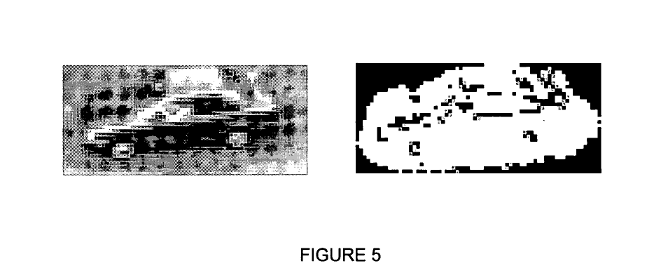

The methods and systems include feature-based correlation and prediction techniques to match vehicles observed in upstream and downstream cameras, using statistical models to compare various object characteristics such as arrival time, departure time, size, shape, position, velocity, acceleration, and color. Certain feature types can be output and/or provided for inspection and processing, such as object size and extent information (e.g., bounding box regions within the image), and object mask images, which are binary images in which zeros indicates background pixels and ones indicate foreground pixels. Mask images have a one-to-one correspondence with “chips” that capture the pixel colors at a given time instant, for example stored in portable pixel map (PPM) format, as shown in FIG. 5.

The disclosed methods and systems acknowledge that a robustness of adaptive background segmentation can be at the cost of object persistence in that objects that stop moving are eventually “absorbed” into the background and lost to a tracker. When these objects begin moving again, the system cannot re-associate to a previously seen track. Accordingly, the disclosed methods and system address this “move-stop-move” problem by determining when a given object has stopped moving. This determination can be useful, for example, in abandoned luggage scenarios described herein. This determination can be accomplished by examining a pre-specified time window over which to monitor an object's motion history. If the object has not moved significantly during this time window, the object can be tagged or otherwise identified as “stopped” or still and saved as an image chip for later use. This saved image chip can be used to determine that a stopped object is still present in the video, and to associate the object with a new track(s) when it begins moving again.

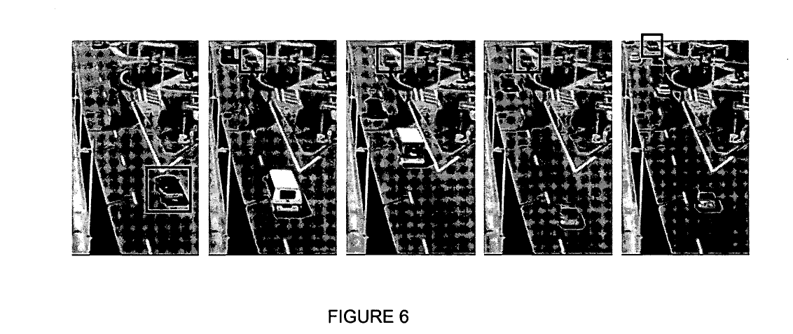

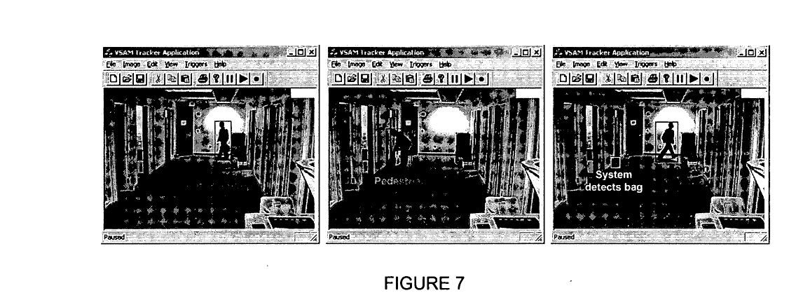

FIGS. 6 and 7 illustrate a move-stop-move problem analysis, where in FIG. 6, a segment of video footage was digitized in which a tracked vehicle stops for a length of time before continuing. Using the disclosed methods and systems, track of the object/vehicle is not lost because the object is not “absorbed” into the background, but rather, marked and monitored based on an examination of a pre-specified time window and the aforementioned recording of an image chip corresponding to the object/vehicle. As provided herein, when the tracked vehicle resumes movement, the track can be continued.

FIG. 7 illustrates a scenario to illustrate detection of abandoned luggage where a tracked individual abandons the luggage. With reference to FIG. 7, the tracked object of the person can be identified and associated with a shape, as can the luggage, where such objects can be tracked individually. Using the methods and systems described herein, based on determining that the luggage is a still object (e.g., non-moving object), a retrospective of images prior to the determination can indicate that the luggage is a still object. Properties of the still object/luggage can be monitored/updated with subsequent views of the area that contains the still object/luggage, and track can begin and/or resume when such properties change.

The FIG. 7 example also provides an example of group tracking that can be employed in the disclosed methods and systems. In group tracking, two or more objects (e.g., person and luggage, multiple people, etc.) can be tracked as a group, thereby allowing for tracking in high-traffic densities. As also shown by the example of FIG. 7, group tracking can include group splitting, and/or group merging.

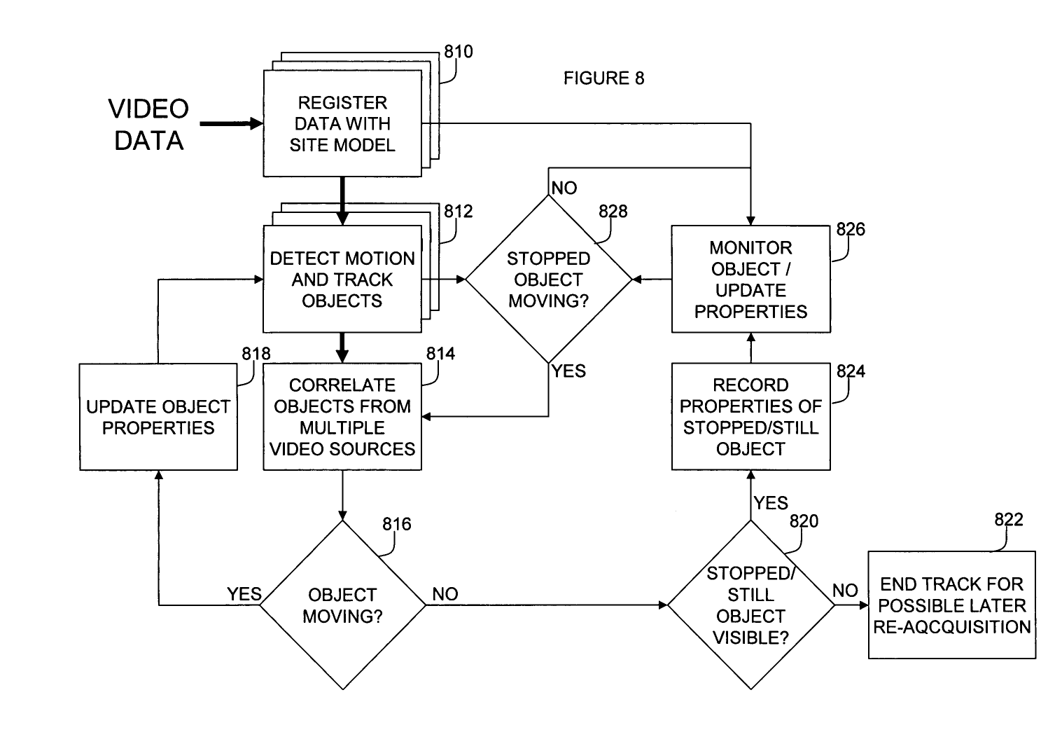

FIG. 8 illustrates a scheme for the aforementioned move-stop-move tracking in which an object can be tracked although the object stops moving, or becomes a “still” object. As FIG. 8 indicates, and as previously provided in FIGS. 1 and 2, video data can be provided from one or more video/camera sources and registered to a site model 810 such that motion can be detected and objects tracked 812 and correlated from multiple video sources 814. Based on the object track, it can be determined whether an object is moving 816, and if the object is moving, object properties (e.g., kinematics, 2D appearance, and/or 3D shape) can be updated 818 and object tracking 812 can continue; however, if it is determined that the object is still (e.g., non-moving) 816, then a second determination can be performed regarding the object's visibility 820. If the object is no longer visible 820, the track can be ended and/or suspended 822 until the object re-appears. Alternatively, if the object is visible 820, object properties (e.g., kinematics, 2D appearance, and/or 3D shape) can be stored/recorded 824 and monitored 826 with subsequent data 810 until it is determined 828 that the object is again moving. As previously described herein, the disclosed methods and systems can allow for a configuration in which an alert is provided to one or more locations (e.g., central location, individual locations, etc.) upon an object being tagged/characterized as “stopped”, non-moving, still, etc., and/or being in such state for more than a specified time. Other examples of alert conditions (e.g., deviation from a model track) are also possible.

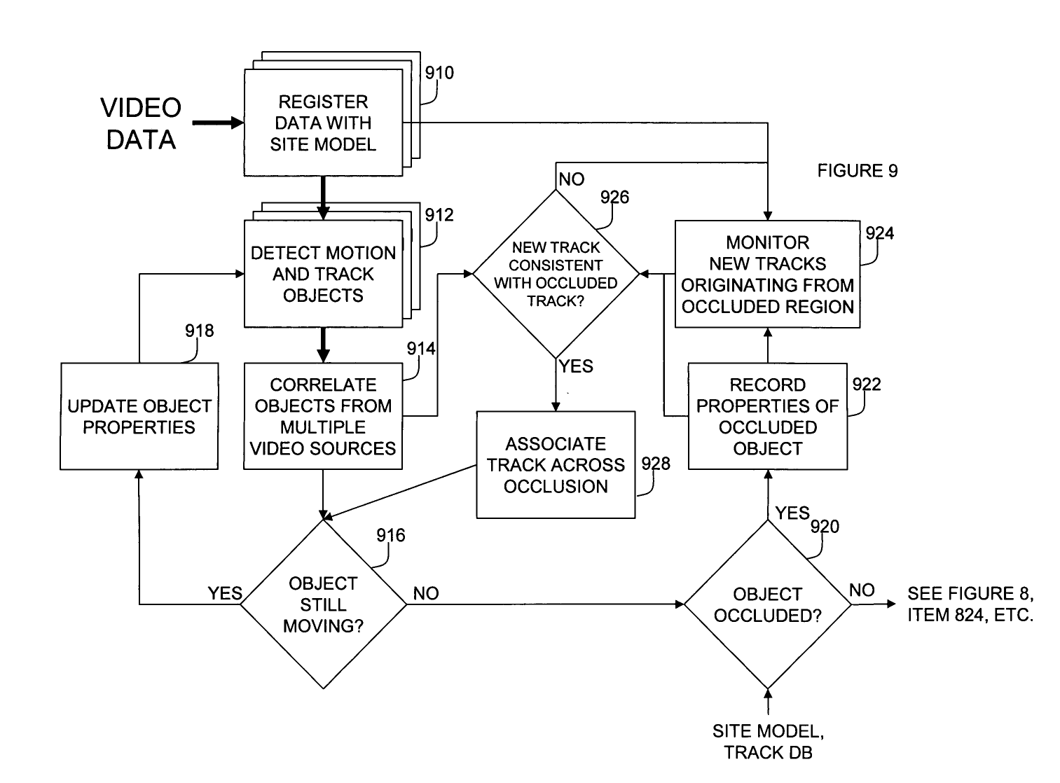

FIG. 9, like FIG. 8, provides for an object that becomes occluded. With reference to FIG. 9, and as provided with respect to FIG. 8, video data can be provided from one or more video/camera sources and registered to a site model 910 such that motion can be detected and objects tracked 912 and correlated across multiple video sources 914. Based on the object track, it can be determined whether an object is moving 916, and if the object is moving, object properties can be updated 918 and object tracking 912 can continue; however, if it is determined that the object is still (e.g., non-moving) 916, then a second determination can be provided regarding whether the object is occluded 920. Object occlusion can be based on, for example, the site model and the track database by examining historical data prior to the object's still motion and/or occlusion. Properties of the occluded object can be recorded/stored 922 and the occluded region can be monitored for new tracks originating from the occluded region and based on subsequent video data 924, until a new track appears that is consistent with the occluded object's track 926. Upon determination of a new track that is consistent with the occluded track 926, the track prior to the occlusion can be associated with the track subsequent to the occlusion 928, and a further determination can be made regarding the movement of the object 916. FIG. 9 thus indicates the continued process of tracking the object through the occlusions.

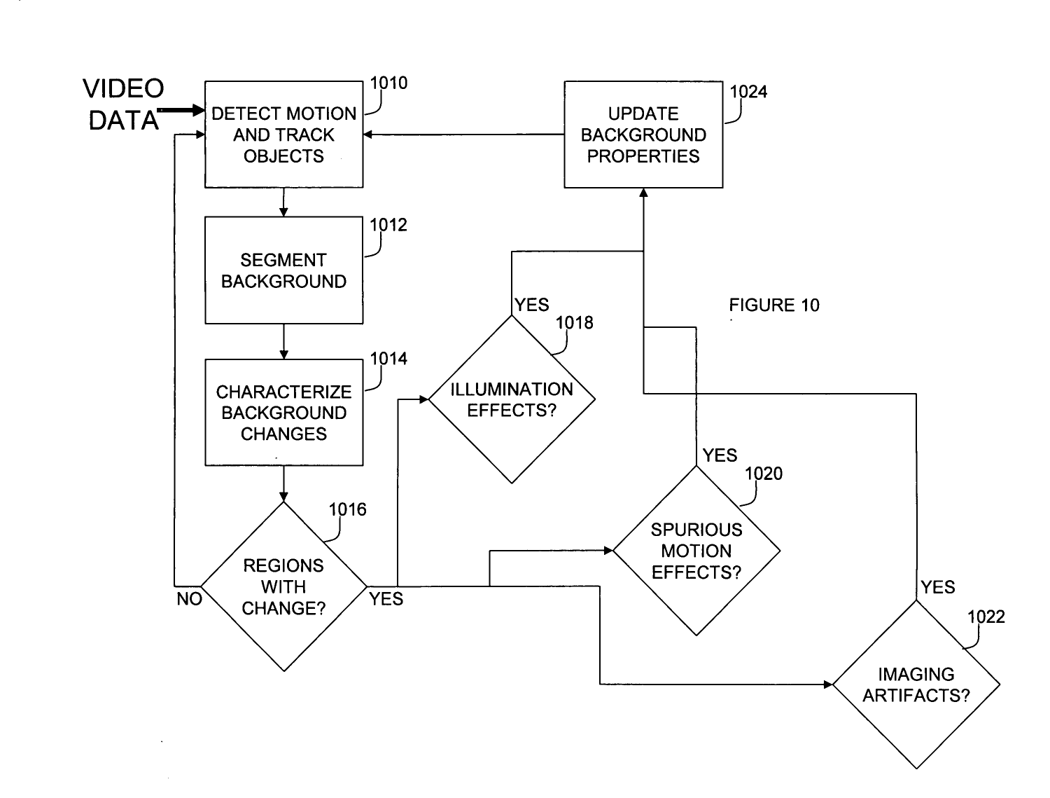

As also provided herein, the disclosed methods and systems allow for tracking through viewpoint changes and lighting changes using a dynamic background adaptation scheme. FIG. 10 provides one example of a dynamic background adaptation scheme in which the video data is provided for the motion detection and object tracking 1010 as previously provided herein, where background segmentation 1012 can be performed to characterize background changes 1014. It can be understood that one or more of several segmentation schemes can be used based on the embodiment. If regions of change in the background (e.g., non-object areas) are determined, detected, and/or found 1016, the FIG. 10 example processing scheme can determine if (e.g., classify) such background changes are illumination effects 1018, spurious motion effects 1020, and/or imaging artifacts 1022 (e.g., noise, glint, etc.), such that the background properties can be updated 1024.

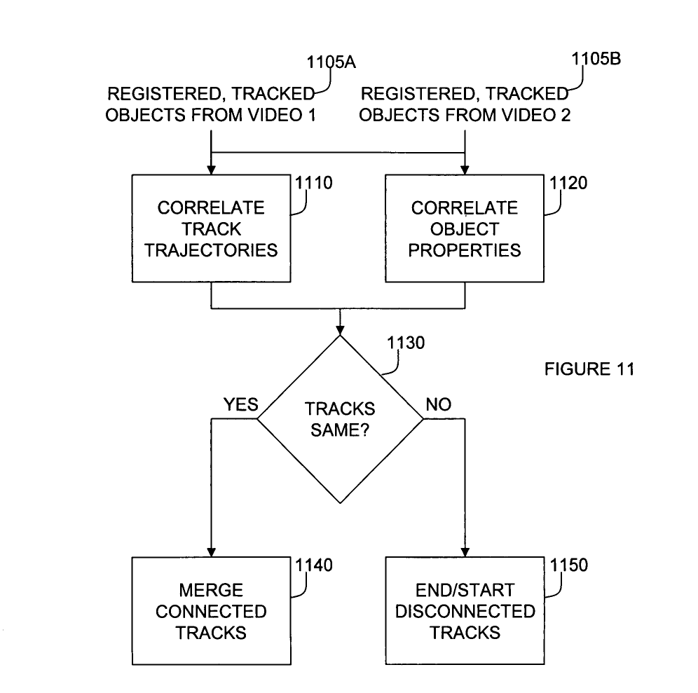

FIG. 11 demonstrates one scheme for tracking an object from different video sources having different fields of view. As FIG. 11 indicates, and with continued reference to FIGS. 1 and 2, registered tracked objects from two video data sources 1105A, 1105B can be provided to one or more correlations schemes 1110, 1120 that correlate the object track trajectories and correlate the object properties from the two video data sources. Based on such correlations, if the tracks are the same 1130, the tracks are merged 1140, and otherwise, the tracks are viewed as distinct such that a particular track may end (e.g., an object track from a first video data source), while another track (e.g., an object track from a second video data source) may begin 1150.

What has thus been described are methods, systems, and computer program products for tracking an object(s), including identifying the object(s) by correlating video data from at least one video device, based on motion data of the object(s) for a previous time, determining that the object(s) movement is stopped, based on determining that the stopped object(s) is not occluded, monitoring the stopped object(s) properties, determining from the monitoring that the stopped object(s) is moving, and, resuming track of the object.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a microprocessor” and “a processor”, or “the microprocessor” and “the processor,” can be understood to include one or more microprocessors that can communicate in a stand-alone and/or a distributed environment(s), and can thus can be configured to communicate via wired or wireless communications with other processors, where such one or more processor can be configured to operate on one or more processor-controlled devices that can be similar or different devices. Use of such “microprocessor” or “processor” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet. References herein to microprocessor instructions or microprocessor-executable instructions, in accordance with the above, can be understood to include programmable hardware.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

1. A method for tracking at least one object, the method comprising:
identifying the at least one object by correlating video data from at least one video device,
based on motion data of the at least one object for a previous time, determining that the at least one object movement is stopped,
based on determining that the at least one stopped object is not occluded, monitoring the at least one stopped object properties,
determining from the monitoring that the at least one stopped object is moving, and, resuming track of the at least one object.

2. A method according to claim 1, where the correlating includes spatially correlating and temporally correlating.

3. A method according to claim 1, where resuming track includes creating a new track.

4. A method according to claim 1, where the at least one stopped object properties include at least one of: kinematic properties, 2D appearance, and 3D shape.

5. A method according to claim 1, where the at least one stopped object properties include at least one of: arrival time, departure time, size, color, position, velocity, and acceleration.

6. A method according to claim 1, where the at least one video device includes at least two cameras having different fields of view.

7. A method according to claim 1, where correlating data includes:
providing a model of at least one field of view, and,
registering the video data to the model.

8. A method according to claim 1, further comprising providing at least one alert based on determining the at least one object is located in a region of interest.

9. A method according to claim 8, where providing an alert includes determining a time that the at least one object entered the region of interest.

10. A method according to claim 1, further comprising providing at least one alert based on a lapse of a time since determining the at least one object entered a region of interest.

11. A method according to claim 1, further comprising:
comparing the at least one object track to a model track, and,
providing an alert based on the comparison of the track to the model track.

12. A method according to claim 1, further comprising:
based on determining that the at least one stopped object is occluded, monitoring new tracks of objects emanating from the region occluding the at least one object.

13. A method according to claim 12, further comprising:
selecting a new track consistent with the track of the at least one occluded object prior to the occlusion, and,
associating the track of the at least one occluded object prior to the occlusion with the selected new track.

14. A method according to claim 1, where correlating video data includes:
detecting motion in the video data to identify objects,
classifying objects from background,
segmenting the background,
detecting background regions with changes, and,
updating the background properties based on determining that the changes are due to at least one of illumination, spurious motion, and imaging artifacts.

15. A method according to claim 1, where correlating video data includes:
detecting moving objects, and,
grouping moving objects based on object tracks.

16. A method according to claim 1, where correlating video data includes:
detecting moving objects, and,
splitting groups of moving objects based on object tracks.

17. A method according to claim 16, where splitting groups of moving object based on tracks includes:
determining that at least one first object in a group is stopped, and,
determining that at least one second object in the group is moving.

18. A method according to claim 1, where correlating data from at least one video device includes:
correlating the track trajectory of the at least one object from a first video device,
correlating the object properties of the at least one object from a second video device, and,
determining, based on the correlation of the track trajectory and correlation of the object properties, to merge at least one track from the first video device and at least one track from the second video device.

19. A method according to claim 18, where determining includes:
determining, based on the correlation of the track trajectory and correlation of the object properties, to not merge at least one track from the first video device and at least one track from the second video device, and,
based on determining, performing at least one of:
ending a track of an object, and,
starting a track of an object.

20. A processor program product having processor-readable instructions for performing a method according to claim 1.
